(19) United States
(12) Patent Application Publication
(10) Pub. No.: US 2008/0063578 A1
(43) Pub. Date: Mar. 13, 2008

(54) System and method for reducing carbonaceous materials

(75) Inventors: Douglas Molohon, Spring Creek, NV (US); Jolene Supp, Wells, NV (US); Michael Eriksen, Wells, NV (US); Kenny Huff, Wells, NV (US); Marla Griswold, Wells, NV (US); John Riddle, Wells, NV (US); William Welsh, Wells, NV (US); Ray Reynolds, Wells, NV (US); William Hylton, Wells, NV (US)

Correspondence Address: THORPE NORTH & WESTERN, LLP., 8180 SOUTH 700 EAST, SUITE 350, SANDY, UT, 84070, US

(73) Assignee: Humboldt Environmental and Renewable Technolgies, Inc.

(21) Appl. No.: 11/518,302

(22) Filed: Sep. 7, 2006

(51) Int. Cl. B01J 19/08

(52) U.S. Cl. 422/186.18

(57) ABSTRACT

A system for reducing carbonaceous material is disclosed. The system includes a compartment configured to receive the carbonaceous material. An auger is located within the compartment and centered about a drive shaft. A rotational drive mechanism is coupled to the drive shaft and configured to rotate the auger to enable the carbonaceous material to travel through the compartment as the auger is rotated. A plurality of lifting arms are coupled to a surface of the auger. The lifting arms are configured to lift and stir the carbonaceous material as the auger is rotated. At least one microwave generator is coupled to the compartment and configured to radiate the carbonaceous material as it travels through the compartment to reduce the carbonaceous material into at least one chemical component of the carbonaceous material.

### BACKGROUND

The present invention relates generally to reducing carbon containing materials. More particularly, the present invention relates to recycling carbonaceous materials using microwave energy.

Discarded materials such as garbage, tires, industrial, agricultural, and mining waste create unsightly, often dangerous sites that are expensive to maintain both environmentally and economically. The waste sites can be damaging to the environment and produce potential toxins such as gasses and dust in the atmosphere as well as minerals and chemicals in the earth and groundwater. The waste sites can require large sites that could otherwise be used for more profitable means. The need for recycling has long been understood, but the cost has often been prohibitive.

Various attempts have been made to recycle some of society's most prolific wastes. For example, U.S. Pat. Nos. 5,507,927, 5,877,395, and 6,133,500 to Emery disclose a method and device for the controlled reduction of organic matter. However, the preferred apparatus disclosed in the patents is a complicated complex including a 60 foot long tunnel having 120 magnetrons, each providing energy over a small area to reduce the organic matter. The Emery patent is suggestive of the various attempts at recycling waste products. The complexity and expense of prior attempts has limited their usefulness in a market economy. Even if prior disclosed devices are successful at reducing waste products into marketable items, the overall expense of purchasing and operating the devices has often been greater than the necessary return on investment to enable recycling to be affordable.

### SUMMARY

A system for reducing carbonaceous material is disclosed. The system includes a compartment configured to receive the carbonaceous material. An auger is located within the compartment and centered about a drive shaft. A rotational drive mechanism is coupled to the drive shaft and configured to rotate the auger to enable the carbonaceous material to travel through the compartment as the auger is rotated. A plurality of lifting arms are coupled to a surface of the auger. The lifting arms are configured to lift and stir the carbonaceous material as the auger is rotated. At least one microwave generator is coupled to the compartment and configured to radiate the carbonaceous material as it travels through the compartment to reduce the carbonaceous material into at least one chemical component of the carbonaceous material.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a diagram of a system for reducing carbonaceous material in accordance with an embodiment of the present invention;

FIG. 2 is a diagram depicting Raman spectroscopy scattering states in accordance with an embodiment of the present invention;

FIG. 3 is a diagram of a system for reducing carbonaceous material displaying a compartment having an optically transparent window for detecting electromagnetic spectra from the carbonaceous material in accordance with an embodiment of the present invention; and

FIG. 4 is a flow chart depicting a method for reducing carbonaceous material in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Prior attempts to recycle or dispose of certain types of carbon containing material have typically involved the use of overly complex devices. The complexity of the devices has limited the types of products that can be recycled in a competitive market environment. What is needed is a simple device that can reduce materials in an efficient and cost effective manner.

Accordingly, a system and method for reducing carbonaceous materials is disclosed. Carbonaceous material includes any material consisting of, containing, relating to, or yielding carbon. This includes, but is not limited to, polymeric material containing polymer chains. Carbonaceous and/or polymeric materials can include, but are not limited to, plastics, rubber, rubber tires including recyclable tires, natural sugar containing products such as corn, sugar cane, sugar beets, and the like, coal, plants and plant byproducts, tar sands, oil shale, and solid waste such as municipal land fill waste. The carbonaceous material can be reduced to form at least one chemical component of the carbonaceous material.

The chemical components from the reduction of carbonaceous materials include gaseous and solid byproducts. The solid byproducts include carbon black and various non-combustible additives such as steel used in rubber tires. Gaseous byproducts can also be produced including various types of hydrocarbons. Other gaseous byproducts such as carbon monoxide and carbon dioxide are also possible.

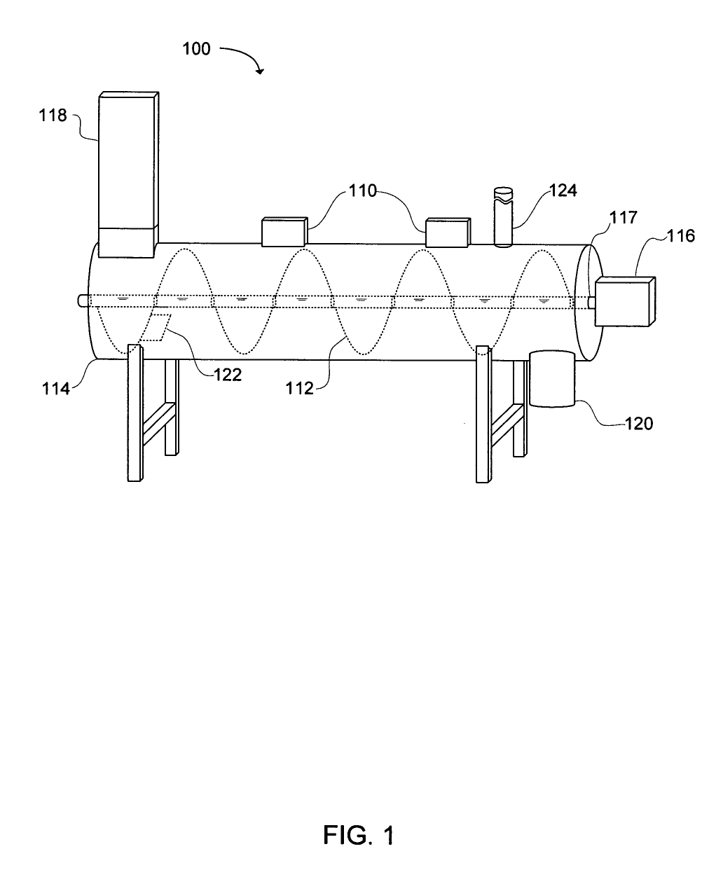

FIG. 1 shows an example embodiment of an efficient and economical system useful for reducing carbonaceous material. The carbonaceous material can be configured to have an average volume that is less, on average, than a predetermined amount. This can be accomplished by chipping, cutting, shredding, or otherwise decreasing in dimension the carbonaceous material into pieces that are, on average, less than the desired volume. For example, in one embodiment, the desired volume of the carbonaceous pieces can be, on average, in the range of 0.1 cubic inches to 100 cubic inches.

The carbonaceous pieces can then be placed into a material feed device 118. The material feed device can be any type of device configured to deliver carbonaceous material into the compartment, such as a hopper, a conveyor belt, etc. The material feed device is configured to dispense the carbonaceous pieces at a preset rate into a compartment 114. An auger 112, located substantially within the compartment, is configured to enable the carbonaceous pieces in the material feed device to travel through the compartment at a preset rate. The auger can include a plurality of lifting arms 122 that are configured to lift and stir portions of the carbonaceous material as the auger is rotated. A rotational drive mechanism 116 is coupled to the auger and configured to rotate the auger to enable the carbonaceous material to travel through the compartment as the auger is rotated. The rotational drive mechanism can rotate the auger using any electrical or mechanical means known, such as an electric motor, an engine, a screw drive, a chain drive, hydraulic powered drive, and the like. The size of the compartment and the auger is based on the predetermined volume of the carbonaceous pieces, as well as other pertinent parameters such as desired throughput, type of material, and so forth. In one embodiment, the compartment and auger can have a length of about 12 feet. The length and width of the compartment and auger, however, is entirely dependent on the type and amount of carbonaceous material being reduced.

The auger 112 and lifting arms 122 can be constructed of metal, ceramic, carbon fiber, or any other type of material capable of withstanding the radiation and temperatures within the compartment for a desired length of time. The lifting arms can be coupled to the auger at an angle which enables the carbonaceous material to be lifted and stirred as the auger rotates. Different types of augers and lifting arms may be used depending on the type of carbonaceous material being reduced within the compartment.

At least one microwave generator 110 is coupled to the compartment 114 and configured to radiate the carbonaceous material as it travels through the compartment. The microwave generator emits radiation in the form of radio frequency (RF) waves. The RF waves can be fed into the compartment directly, or directed using directional means such as a waveguide. The RF waves can be generated by any means capable of producing energetic microwaves. For example, in one embodiment the RF waves can be generated using one or more magnetrons, though any type of microwave source having sufficient power output can be used. Each magnetron can generate from several hundred watts to tens of kilowatts of RF energy. In one embodiment, the RF waves can be produced at a frequency of 2.45 GHz, though any frequency capable of exciting molecules within the carbonaceous material can be used. The magnetrons can be operated using a pulsed or continuous wave steady state power source.

The electromagnetic field within the compartment 114 that is produced by the at least one microwave generator 110 is typically a non-uniform field that varies in intensity throughout the compartment due to reflections of the RF energy from the auger 112 as the auger is rotated. The RF energy distribution can also be affected due to the RF wave reflections from the lifting arms 122 and potentially reflective carbonaceous pieces as the pieces travel through the compartment and are lifted and stirred by the plurality of lifting arms in a substantially random and chaotic manner due to the rotating auger. The random movement of the carbonaceous pieces as the pieces travel through the compartment enables the pieces to receive substantially even heating despite the substantially continuously varying RF energy.

Theoretically, the RF energy emitted by the at least one microwave generator 110 excites the molecules within the carbonaceous pieces to a level at which the pieces are reduced into at least one chemical component of the material. The carbonaceous materials can be reduced by the microwave energy through generation of heat due to excitation of the molecules and/or breaking of chemical bonds within the material. Temperatures within the compartment 114 can reach levels of 750° C. or more. Different types of carbonaceous materials break down at different temperatures. The temperature of the carbonaceous material can be controlled by the rotational velocity of the auger. This will be discussed more fully below.

The amount of carbonaceous material within the compartment can be controlled to enable the carbonaceous material to be lifted and stirred a sufficient amount to enable the material to receive substantially even heating from the microwave generator(s) 110. The amount of carbonaceous material that can be placed within the compartment is dependent upon the type of carbonaceous material being reduced.

For example, in one embodiment rubber tires can be chipped, cut, or shredded to a predetermined average size, such as 2 inch×2 inch squares, with a thickness dependent upon the type of tire being recycled. The tire pieces can be placed into the material feed device 118. The material feed device can dispense the tire pieces into the compartment. The rotating auger 112 can work in cooperation with the material feed device to ensure that the auger is not filled more than a predetermined amount. In one embodiment, the auger can be filled to not more than 60% capacity. The remaining 40% of empty volume within the auger enables the tire pieces to be lifted and stirred within the compartment so that the tire pieces are substantially evenly heated by the microwave generator(s) 110.

The solid byproducts of the carbonaceous material travel through the compartment 114 and exit through a product discharge chute 120. The solid byproducts can be emitted into a sorting bin (not shown). In one embodiment, the sorting bin can include a liquid such as water used to cool the solid byproducts and allow for the efficient separation of carbon black and the various additives such as steel.

The gaseous byproducts can exit the compartment 114 through an exhaust manifold 124. In order to prevent combustion of the solid and gaseous byproducts, a substantially non-oxygen atmosphere is introduced within the compartment 114. Some of the gaseous byproducts can be condensed into a variety of liquid hydrocarbons, such as oil, methanol, diesel fuel, and the like. The types of gaseous byproducts and condensed liquids produced are dependant on the kind(s) of carbonaceous material being reduced.

In another embodiment, additional components may be added to the carbonaceous material within the compartment 114. The additives can act as an accelerant to enhance the reduction of the carbonaceous material. For example, carbon black added to rubber tire pieces may accelerate the reduction of the tire pieces into various chemical components. Alternatively, the additives may be an ingredient used to achieve a desired end product. For example, oxygen and steam can be combined with coal under high pressure within the compartment and heated using the microwave generator(s) to produce carbon monoxide and hydrogen. The gasses can be collected through the exhaust manifold 124, or further processed to create diesel fuel.

In another embodiment, the speed of the auger 112 can be varied using the rotational drive mechanism 116 that is coupled to the auger. The rotational drive mechanism can be coupled to a drive shaft 117 at a center of the auger, as previously disclosed. The auger can then be rotated about the drive shaft. The speed of the auger can be varied depending on a temperature of the carbonaceous material. A temperature of the carbonaceous material can be taken at one or more points within the compartment 114. The speed of the rotational drive mechanism can be increased or decreased depending on the temperature reading(s) at selected points. If the temperature of the carbonaceous materials, and/or its chemical components, is greater than a desired level, the speed of the rotational drive mechanism can be increased to move the carbonaceous materials through the compartment more quickly. Conversely, if the temperature is lower than a desired level, the speed of the auger can be reduced to enable the temperature of the carbonaceous material to be increased before the chemical component(s) exit through the exhaust manifold 124 and discharge chute 120.

Measuring the temperature of the carbonaceous materials within the compartment is difficult due to microwave radiation, the high temperatures, and the moving auger and carbonaceous pieces within the compartment. Conventional thermometers placed within the compartment may be damaged, inaccurate, or have a significantly shortened life span due to the harsh environment within the compartment. In one embodiment, the temperature of the carbonaceous materials can be measured at a desired point within the compartment without the use of invasive instruments. In one non-limiting example, an optical measurement of the carbonaceous material can enable the temperature to be determined using the Raman Effect. Other types of non-invasive temperature measurements are also within the scope of this patent.

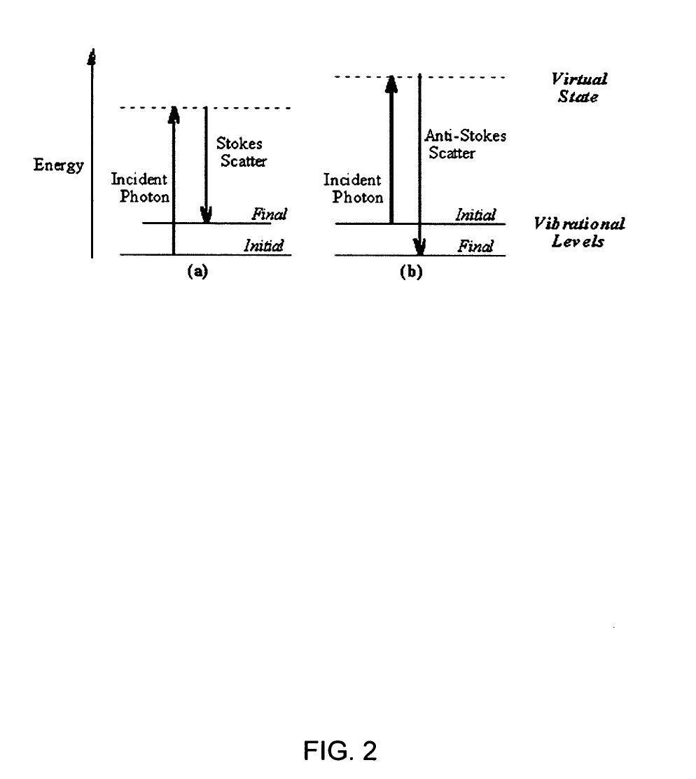

The Raman Effect arises when a photon is incident on a molecule and interacts with the electric dipole of the molecule. It is a form of electronic, or more accurately, vibronic spectroscopy. The interaction can be viewed as a perturbation of the molecule's electric field. In quantum mechanics the scattering is described as an excitation to a virtual state lower in energy than a real electronic transition with nearly coincident de-excitation and a change in vibrational energy. A diagram representing a virtual state description is shown in FIG. 2a.

The energy difference between the incident and scattered photons is represented by the arrows of different lengths in FIG. 2a. Numerically, the energy difference between the initial and final vibrational levels, v̅, or Raman shift in wave numbers (cm⁻¹), is calculated using the equation below:

$$\overline{v} = \frac{1}{{λ}_{incident}} - \frac{1}{{λ}_{scattered}} \qquad$$

in which λ_{incident} and λ_{scattered} are the wavelengths (in cm) of the incident and Raman scattered photons, respectively.

At room temperature the thermal population of vibrational excited states is low, although not zero. Therefore, the initial state is the ground state, and the scattered photon will have lower energy (longer wavelength) than the exciting photon. This Stokes shifted scatter is what is usually observed in Raman spectroscopy. FIG. 2a depicts Raman Stokes scattering. A small fraction of the molecules are in vibrationally excited states. Raman scattering from vibrationally excited molecules leaves the molecule in the ground state. The scattered photon appears at higher energy, as shown in FIG. 2b. This anti-Stokes-shifted Raman spectrum is always weaker than the Stokes-shifted spectrum. The Stokes and anti-Stokes spectra contain the same frequency information. The ratio of anti-Stokes to Stokes intensity at any vibrational frequency is a measure of temperature. Thus, the ratio can be used to determine a substantially accurate temperature of the carbonaceous material by measuring the spectra of the material.

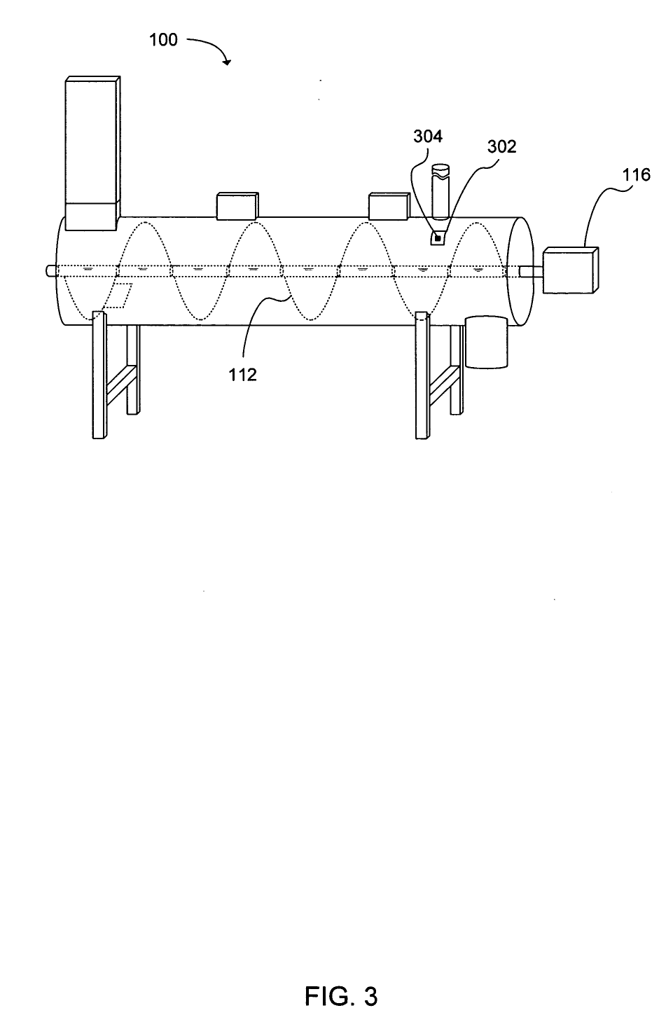

As shown in FIG. 3, the spectra of the carbonaceous material can be measured using at least one Raman spectroscopy device 304 configured to emit photons onto the carbonaceous material and measuring Stokes and anti-Stokes spectra emitted by the material. The Raman spectroscopy device can be placed at a location external to the compartment. An optically transparent window 302 can be formed in a wall of the compartment to enable the Raman spectroscopy device to emit photons and detect the desired spectra. The photons can be emitted by a coherent light source such as a laser. The optically transparent window can be configured to be substantially opaque to the microwave radiation within the compartment while allowing the coherent light source to penetrate the window. The Raman spectroscopy device can be electrically coupled to the rotational drive mechanism 116. A feedback loop can be formed between the Raman spectroscopy device and the rotational drive mechanism enabling the speed of the rotational drive mechanism to be automatically adjusted to increase or decrease the rotational velocity of the auger 112 to obtain a desired temperature of the carbonaceous material at the point of the measurement. Multiple windows and sensor devices can be used to obtain the temperature of the carbonaceous material at a plurality of locations along the compartment. Electrical control and/or logic devices can be coupled between the Raman spectroscopy device and the rotational drive mechanism to enable the desired control, as known to one skilled in the art.

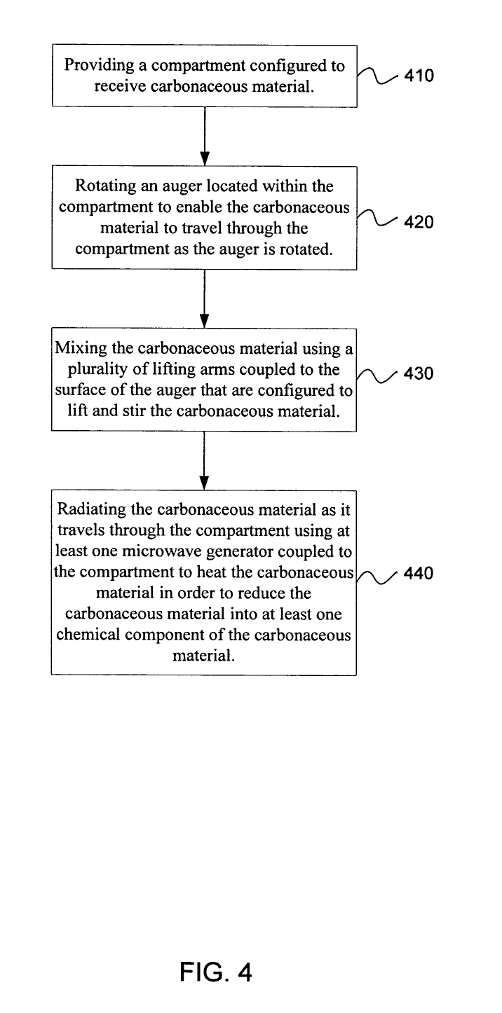

In another embodiment, a method for reducing carbonaceous material is disclosed, as shown in the flow chart of FIG. 4. The method includes the operation of providing a compartment configured to receive carbonaceous material, as shown in block 410. A further operation includes rotating an auger located within the compartment to enable the carbonaceous material to travel through the compartment as the auger is rotated, as shown in block 420. An additional operation provides mixing the carbonaceous material using a plurality of lifting arms coupled to the surface of the auger that are configured to lift and stir the carbonaceous material, as shown in block 430. A further operation includes radiating the carbonaceous material as it travels through the compartment using at least one microwave generator coupled to the compartment to heat the carbonaceous material in order to reduce the carbonaceous material into at least one chemical component of the carbonaceous material, as shown in block 440.

The temperature of the carbonaceous material can be measured at one or more locations along the compartment, as previously discussed. A rate of rotation of the auger can be adjusted in response to the measurement of the temperature of the carbonaceous material. By increasing or decreasing the speed of rotation of the auger, the temperature of the carbonaceous material can be decreased or increased, respectively. The temperature can be determined using non-invasive methods. One non-invasive method for measuring the temperature of the carbonaceous material is through the use of Raman spectroscopy by emitting photons onto the carbonaceous material, detecting the electromagnetic radiation emitted in response to the photons, and determining a ratio in intensity between Stokes spectra and anti-Stokes spectra due to the photons.

The system(s) and method(s) disclosed for reducing carbonaceous material are simple and cost effective. The use of the auger combined with the lifting arms reduces the complexity of the device by enabling the use of a simple compartment coupled to microwave generators that can produce non-uniform electromagnetic fields. As the carbonaceous material is lifted and stirred, the material is substantially evenly heated. The heating enables the material to be reduced into one or more chemical components. The chemical components can be sold and/or reused to produce other products. By creating a marketable means for reducing carbonaceous materials, discarded materials such as garbage, tires, industrial, agricultural, and mining waste can be effectively recycled and reused, reducing unsightly storage locations and improving the overall environment.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for reducing carbonaceous material, comprising:
a compartment configured to receive the carbonaceous material;
an auger located within the compartment and centered about a drive shaft;
a rotational drive mechanism coupled to the drive shaft and configured to rotate the auger to enable the carbonaceous material to travel through the compartment as the auger is rotated;
a plurality of lifting arms coupled to a surface of the auger, wherein the plurality of lifting arms are configured to lift and stir the carbonaceous material as the auger is rotated; and
at least one microwave generator coupled to the compartment and configured to radiate the carbonaceous material as it travels through the compartment to reduce the carbonaceous material into at least one chemical component of the carbonaceous material.

2. A system as in claim 1, wherein each of the at least one microwave generators is coupled to a waveguide configured to direct the microwave energy from the microwave generator into the compartment.

3. A system as in claim 1, wherein an electromagnetic field within the compartment that is generated by the microwave generators is a non-uniform field that varies in intensity throughout the compartment as the auger is rotated.

4. A system as in claim 1, further comprising a material feed device coupled to the compartment and configured to dispense the carbonaceous material into the compartment at a preset rate.

5. A system as in claim 1, wherein the carbonaceous material is configured to have a volume that is averagely less than a predetermined amount.

6. A system as in claim 5, wherein the predetermined amount is between 0.1 cubic inches and 100 cubic inches.

7. A system as in claim 1, wherein the carbonaceous material includes pieces of recyclable tires.

8. A system as in claim 1, wherein the auger located within the compartment is filled to less than 60% capacity to enable the carbonaceous material to be lifted and stirred as the auger is rotated.

9. A system as in claim 1, further comprising a product discharge chute configured to discharge at least one solid component of the carbonaceous material.

10. A system as in claim 1, further comprising an exhaust manifold configured to collect at least one gaseous component of the carbonaceous material.

11. A system as in claim 1, wherein a speed at which the auger is rotated is varied based on a temperature of the carbonaceous material within the compartment.

12. A system as in claim 1, wherein a temperature of the carbonaceous material is determined using Raman scattering by determining a ratio in intensity between Stokes spectra and anti-Stokes spectra taken from the carbonaceous material at a predetermined location within the compartment.

13. A system as in claim 1, further comprising a feedback system electrically coupled between a temperature detector and the rotational drive mechanism, wherein the feedback system is configured to control a rotational velocity of the auger based on an output of the temperature detector.

14. A method for reducing carbonaceous material, comprising:
providing a compartment configured to receive carbonaceous material;
rotating an auger located within the compartment to enable the carbonaceous material to travel through the compartment as the auger is rotated;
mixing the carbonaceous material using a plurality of lifting arms coupled to the surface of the auger that are configured to lift and stir the carbonaceous material; and
radiating the carbonaceous material as it travels through the compartment using at least one microwave generator coupled to the compartment to heat the carbonaceous material in order to reduce the carbonaceous material into at least one chemical component of the carbonaceous material.

15. A method as in claim 14, further comprising measuring a temperature of the carbonaceous material at one or more locations along the compartment.

16. A method as in claim 15, further comprising adjusting a rate of rotation of the auger in response to a measurement of the temperature of the carbonaceous material, wherein the rate of rotation is adjusted to enable the carbonaceous material to reach a desired temperature at a point of the temperature measurement.

17. A method as in claim 14, further comprising determining a temperature of the carbonaceous material using Raman scattering by determining a ratio in intensity between Stokes spectra and anti-Stokes spectra taken from the carbonaceous material at a predetermined location within the compartment

18. A method as in claim 14, further comprising discharging at least one solid component of the at least one chemical component from the compartment through a product discharge chute.

19. A method as in claim 14, further comprising collecting at least one gaseous component of the at least one chemical component from the compartment through an exhaust manifold.

20. A method as in claim 14, further comprising adding additional reactive components into the compartment with the carbonaceous material.

21. A means for reducing carbonaceous material, comprising:
a means for loading carbonaceous material into a compartment;
an auger located within the compartment and configured to rotate about a center axis;
a rotational drive means coupled to the center axis and configured to rotate the auger within the compartment to enable the carbonaceous material to travel through the compartment as the auger is rotated;
a mixing means coupled to the rotational drive means for lifting and stirring the carbonaceous material as it travels through the compartment; and
a microwave energy emitting means for generating an electromagnetic field within the compartment, wherein the field has a sufficient strength to heat the carbonaceous material to enable the material to be reduced into at least one chemical component of the carbonaceous material.

22. A means for reducing carbonaceous material, as in claim 21, further comprising a temperature measurement means for determining a temperature of the carbonaceous material within the compartment at a desired location.

23. A means for reducing carbonaceous material, as in claim 22, further comprising a feedback means between the temperature measurement means and the rotational drive means to enable a rotational rate of the auger to be controlled based on a temperature of the carbonaceous material.
